(19) United States
(12) Patent Application Publication
(10) Pub. No.: US 2008/0119598 A1
(43) Pub. Date: May 22, 2008

(54) Treated Inorganic Metal Containing Powders and Polymer Films Containing Them

(75) Inventor: Donald Douglas May, Chadds Ford, PA (US)

Correspondence Address: Sinnot, Jessica M.;E.I. Du Pont De Nemours and Company, Legal Patent Records Center, 4417 Lancaster Pike, Wilmington, DE, 19805, US

(73) Assignee: E.I. DU PONT DE NEMOURS AND COMPANY, WILMINGTON, DELAWARE, DE (US)

(21) Appl. No.: 11/795,098

(22) PCT Filed: Jan. 13, 2006
(86) PCT No.: PCT/US06/01548

§ 371 Date: Jul. 10, 2007

Related U.S. Application Data
(60) Provisional application No. 60/643,980, filed on Jan. 14, 2005.

(51) Int. Cl. C08K 3/30

(52) U.S. Cl. 524/262; 524/425; 524/432; 524/445; 524/451; 524/493; 524/423; 524/431; 525/475; 525/326.5

(57) ABSTRACT

An antistatic agent useful for mixing with thermoplastic polymers is disclosed which comprises a reaction product of an inorganic pigment, more typically TiO₂; optionally at least one silane; and a siloxane compound.

### CROSS-REFERENCE TO RELATED APPLICATIONS

This application claims the benefit of U.S. Provisional Application No. 60/643,980, filed on Feb. 14, 2005 incorporated by reference herein in its entirety.

### BACKGROUND OF THE DISCLOSURE

1. Field of the Disclosure

The present disclosure relates to treated inorganic pigments, more particularly treated titanium dioxide, and a process for their preparation and their use in thermoplastic polymer compositions to impart antistatic properties to resultant plastic parts.

2. Description of the Related Art

High molecular weight polymers, for example, hydrocarbon polymers and polyamides, are melt extruded into shaped structures such as tubing, pipe, wire coating or film by well-known procedures wherein a rotating screw pushes a viscous polymer melt through an extruder barrel into a die in which the polymer is shaped to the desired form, and is then subsequently cooled and solidified into a product, that is, the extrudate, having the general shape of the die. In film blowing processes, as an extruded plastic tube emerges from the die the tube is continuously inflated by air, cooled, collapsed by rolls and wound up on subsequent rolls.

Inorganic pigments are added to the thermoplastic polymer. In particular, titanium dioxide pigments are added to thermoplastic polymers for imparting whiteness and/or opacity to the finished article. To deliver other properties to the molded part or film, additional additives are incorporated into the processing step. What is needed is a titanium dioxide that has multiple properties associated with it.

One of these properties is charge dissipation known as antistatic. Additive treatment with an anti-electrostatic (“antistatid”) can reduce the surface resistance and dust-attracting tendency of plastics. In order to get this property in colored films, that is; those that are not black, a separate additive known as an antistatic agent may be added to the polymer composition during processing. This process adds additional cost and complexity to the process. What is needed is a non black pigment which imparts color and opacity along with charge dissipation.

Commercially available additives for antistatic treatment of plastics are, for example, alkyl- and aryl-sulfonates, ethoxylated alkylamines, quaternary ammonium, and phosphonium salts and fatty acid esters. Specific polyalkylane ethers/polyalkylene glycols have also been described for antistatic treatment of plastics. Other examples of antitstatic additives that have been described are ethoxylated long-chain aliphatic amines, long chain aliphatic amines, and amides, and phosphate esters.

Certain polysiloxanes have been known as “superwetters” for use in agricultural sprays, such as herbicides, fungicides or insecticides, for facilitating wet-out of the spray onto the plant or plant leaves to enhance application of the agricultural spray to the plant or plant leaf. Use of such polysiloxanes as antistatic agents in plastics is not known.

U.S. Pat. No. 6,497,933 discloses antistatic coatings containing Silwet L-77 sold by Osi Specialties of Danbury, Conn. as a surfactant. The '933 patent describes applying the antistatic coating to a film surface. Nothing in the '933 patent teaches or suggests that Silwet 77 has antistatic properties or mixing Silwet 77 into a thermoplastic polymer melt.

### SUMMARY OF THE DISCLOSURE

The present disclosure is directed to an antistatic agent comprising an inorganic pigment having a polysiloxane treatment, the polysiloxane having the structure:

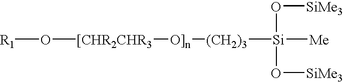

wherein
R₁, R₂ and R₃ are independently hydrogen atom, or C₁-C₂₀ alkyl group and n is independently an integer between 1 and 40. In one embodiment of the disclosure R₁, R₂ and R₃ are independently hydrogen atom or methyl group and n is 1 to 40, typically 6 to 40, more typically 6 to 12. In another embodiment R₁ and R₂ and R₃ are hydrogen atoms and n is 1 to 40, typically 6 to 40, more typically 6 to 12.

In one embodiment the pigment is titanium dioxide. In yet another embodiment the pigment is silanized titanium dioxide.

The disclosure additionally relates to films comprising a thermoplastic polymer and the antistatic agent of this disclosure, more typically, white films and the antistatic agent of this disclosure. The disclosure more additionally relates to shaped articles made from thermoplastic polymers comprising the antistatic agent of the disclosure.

The disclosure additionally relates to processes for making the antistatic agent and mixing the antistatic agent with a thermoplastic polymer.

The disclosure additionally relates to a method of making a pigmented thermoplastic polymer composition for forming thermoplastic products having reduced surface resistance, comprising:

mixing an inorganic pigment with an antistatic agent to form a pigment having antistatic treatment, and

dispersing the pigment having antistatic treatment into a thermoplastic polymer melt to form the pigmented thermoplastic polymer composition.

### DETAILED DESCRIPTION OF THE DISCLOSURE

The disclosure relates to an antistatic agent, particularly an antistatic agent for plastics. The disclosure further relates to a process for treating an inorganic pigment, typically a titanium dioxide pigment, to form a treated pigment capable of being added to a thermoplastic polymer melt to impart antistatic properties to a plastic part formed therefrom. While not wishing to be limited to any theory or mechanism, the antistatic agent provides hydrophilicity to the thermoplastic polymer surface which provides static charge reduction. Additionally, while not wishing to be limited by any theory or mechanism the organic pigment can function, at least in part, as a carrier for the polysiloxane. During polymer processing at least a portion of the polysiloxane can become dissociated from the pigment and bloom to the surface of the thermoplastic polymer to reduce surface resistance.

The treated titanium dioxide pigment containing film has reduced surface resisitivity. The resulting film can have a surface resistivity of less than about 10 E¹⁴ ohms/cm², more typically a surface resistivity of less than 10 E¹¹ ohms/cm².

### Treated Pigment:

It is contemplated that any inorganic pigment will benefit from the treatment of this disclosure. By inorganic pigment it is meant an inorganic particulate material that becomes uniformly dispersed throughout a thermoplastic polymer melt and imparts color and opacity to the thermoplastic polymer melt. Some examples of inorganic pigments include but are not limited to ZnS, TiO₂, CaCO₃, BaSO₄, ZnO, MoS₂, silica, talc and clay. In particular, the pigment disclosed herein is an inorganic metal-containing pigment such as titanium dioxide. In this disclosure, where titanium dioxide is specifically mentioned it is contemplated that any of the inorganic pigments would be suitable.

Titanium dioxide (TiO₂) pigment useful in the present disclosure may be in the rutile or anatase crystalline form. It is commonly made by either a chloride process or a sulfate process. In the chloride process, TiCl₄ is oxidized to TiO₂ particles. In the sulfate process, sulfuric acid and ore containing titanium are dissolved, and the resulting solution goes through a series of steps to yield TiO₂. Both the sulfate and chloride processes are described in greater detail in “The Pigment Handbook”, Vol. 1, 2nd Ed., John Wiley & Sons, NY (1988), the teachings of which are incorporated herein by reference.

By “pigment”, especially with reference to titanium dioxide, the pigment particles can have an average size of less than 1 micron. Typically, the particles have an average size of from 0.020 to 0.95 microns, more typically, 0.050 to 0.75 microns and most typically 0.075 to 0.50 microns.

The pigment may be substantially pure titanium dioxide or may contain other metal oxides, such as silica, alumina, zirconia. Other metal oxides may become incorporated into the pigment particles, for example, by co-oxidizing or co-precipitating titanium compounds with other metal compounds. If co-oxidized or co-precipitated metals are present, they are typically present in an amount 0.1 to 20 wt %, as the metal oxide, more typically, 0.5 to 5 wt %, most typically 0.5 to 1.5 wt % based on the total pigment weight.

The titanium dioxide pigment may also bear one or more metal oxide coatings. These coatings may be applied using techniques known by those skilled in the art. Examples of metal oxide coatings include silica, alumina and zirconia among others. Such coatings may be present in an amount of 0.1 to 10 wt %, based on the total weight of the pigment, preferably 0.5 to 3 wt %.

In the process for treating the pigment, the pigment particles are contacted with one or more of the polysiloxanes of this disclosure. Additionally, when the pigment is contacted with one or more of the polysiloxanes described herein the compounds can be adsorbed on the surface of the particle or, a reaction product of the polysiloxane and optional silane with the particle can be present on the surface as an adsorbed species or chemically bonded to the surface. The polysiloxane and optional silane, or their reaction products or combinations thereof may be present as a coating, continuous or non-continuous, on the surface of the pigment. Typically, a continuous coating comprising the polysiloxane, and the optional silane, is on the surface of the pigment.

In the present disclosure, the polysiloxane has the structure:

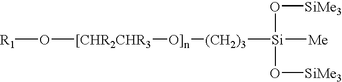

wherein
R₁, R₂ and R₃ are independently hydrogen atom, or C₁-C₂₀ alkyl group and n is independently an integer between 1 and 40, typically 6 to 40, more typically 6 to 12. The polysiloxane can have a weight average molecular weight ranging from about 300 to about 2000, more typically, from about 500 to about 1500. The polysiloxanes can be random or block polymers.

In one embodiment of the dislosure R₁ and R₂ and R₃ are independently hydrogen atoms or methyl groups and n is an integer ranging from 1 to 40, typically 6 to 40, more typically 6 to 12.

In another embodiment of the disclosure R₁ and R₂ and R₃ are hydrogen atoms and n ranges from 1 to 40, typically 6 to 40, more typically 6 to 12.

A suitable polyethoxylated polysiloxanes has the CAS name poly(oxy-1,2-ethanediyl), a-[3-[1,3,3,3-tetramethyl-1 (trimethylsilyl)oxy]disiloxanyl]propyl]-w-hydroxy-(CAS number 67674-67-3) and is commercially available from Dow Corning as 5212; Q 2-5211; Q 2-5212; and Qwikwet 100; Qwikwet 357; and Silwet 408, and Break-thru S-200

The polyethyoxylated polysiloxane Q2-5211 has the structure:

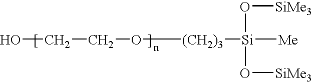

Additional suitable polysiloxanes are methyl capped polyethoxylated polysiloxanes which have a structure similar to that of Q2-5211 except instead of having a terminal hydroxyl group there is a methoxy group. Such structures have the CAS Name—Poly(oxy-1,2-ethanediyl), a-methyl-w-[3-[1,3,3,3-tetramethyl-1-[(trimethylsilyl)oxy]disiloxanyl]propoxy] and CAS Number 27306-78-1. Commercially available methyl capped polyethoxylated polysiloxanes include Tegopren 5878 sold commercially by Degussa and Silwet L-77.

A yet additional suitable polysiloxane is a mixed oxirane and methyl oxirane polysiloxane. An example of such a polysiloxane is a mixed oxirane and methyl oxirane polymer of mono[3-[1,3,3,3-tetramethyl-1-[(trimethylsilyl)oxy]disiloxanyl]propyl]ether (CAS Number 134180-76-0) commercially sold as Tegopren 5840 by Degussa. This mixed oxirane polysiloxane is a reaction product of a siloxane having the structure:

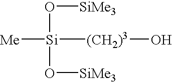

and the oxirane monomers:

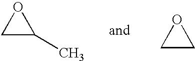

The polysiloxane can be present in the amount of about 0.1 to about 5 weight %, based on the total amount of the treated pigment.

The silane compound, that may optionally be used to treat the pigment, comprises a silane monomer. Suitable silane monomers are those in which at least one substituent group of the silane contains an organic substituent. The organic substituent can contain heteroatoms such oxygen or halogen. Typical examples of suitable silanes include, without limit, alkoxy silanes and halosilanes having the general formula RₓSi(R′)₄₋ₓ, wherein R is a nonhydrolyzable aliphatic group. The group R can have the structure:

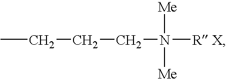

wherein R′ is a C₁-C₂₀ hydrocarbon, and X is an ion selected from Cl, Br, or HSO₄; and R′ is a hydrolyzable group such as an alkoxy, halogen, acetoxy or hydroxy or mixtures thereof; and x is an integer ranging from 1 to 3.

The nonhydrolyzable group will not react with water to form a different group. The hydrolysable group will react with water to form one or more different groups, which become adsorbed or chemically bonded to the surface of the titanium dioxide particle. Typically, R″ is C₆ to C₁₈ alkyl group, additionally R″ is a C₆ to C₁₈ straight chain alkyl group. Typically, R′ is an alkoxy group having about 1 to about 4 carbon atoms, preferably, ethoxy or methoxy; a halogen, such as chloro or bromo; or acetoxy or hydroxy or mixture thereof. Preferably R′ is chloro, methoxy, ethoxy, hydroxy, or mixture thereof.

Some useful silanes may be selected from the group of 3-trimethoxysilyl propyl octyl dimethyl ammonium chloride, 3-trimethoxysilyl propyl octyl dimethyl ammonium chloride, 3-trimethoxysilyl propyl decyl dimethyl ammonium chloride, 3-trimethoxysilyl propyl hexadecyl dimethyl ammonium chloride, and 3-trimethoxysilyl propyl octadecyl dimethyl ammonium chloride.

The silane is present in the amount of about 0.1 to about 5 weight %, based on the total amount of the treated pigment.

The process of treating pigment particles with the first and second compounds is not especially critical and may be accomplished in a number of ways. While typically the pigment is treated with the optional silane, if present, and then the polysiloxane compound in sequence, the pigment may be treated with the polysiloxane compound and the optional silane compound simultaneously.

The process of treating the pigment may be performed by contacting dry pigment with neat compound or in an appropriate solvent that one skilled in the art can select. When a silane is employed the compound may be prehydrolzyed, then contacted with dry pigment. Alternatively, the treating compounds may be dissolved in a solvent or prepared as a slurry before contacting pigment, in dry or slurry form. In addition, the pigment may be immersed in the treating compound, if liquid, or a solution, of the treating compound or compounds is used. For example, mixing may be accomplished using a V-cone blender fitted with an internal stirring bar at ambient temperature for 15 minutes. Alternately, mixing may be accomplished by spraying the treating compounds on the pigment followed by shaking for about 10- about 15 minutes. Mixing may also be accomplished by the steps comprising:

(i) metering the antistatic agent, preferably the polysiloxane and optionally the silane into a flow restrictor, having an inlet and an outlet, with air or some other motive gas, to create a zone of turbulence at the outlet of the flow restrictor thereby atomizing the antistatic agent, preferably the polysiloxane and optionally the silane to form an atomized liquid; and

(ii) contacting the pigment with the atomized liquid to form a treated powder comprising the pigment, the antistatic agent, preferably the polysiloxane and optionally the silane. The atomized liquid may be substantially uniformly coated on the surface of the pigment.

The amount of pigment present in the pigmented thermoplastic polymer composition and shaped polymer article will vary depending on the end use application. A suitable antistatic effective amount of the treated pigment will be apparent to those skilled in the art of thermoplastic polymer compounding and also the amount in the thermoplastic polymer composition or shaped polymer article can vary depending on the end use application and the amount of charge dissipation which is useful to an end user. Typically, the amount of treated pigment in the thermoplastic polymer composition can range from about 30 to about 90 wt %, based on the total weight of the composition, preferably, about 50 to about 80 wt %. The amount of treated pigment in an end use shaped polymer article, for example, a polymer film, can range from about 0.01 to about 20 wt %, and is preferably from about 0.1 to about 15 wt %, more preferably 5 to 10 wt %.

The antistatic effective performance of the treated pigment can be determined by measuring the surface resistivity of a film formed from the thermoplastic composition having the treated pigment mixed therein. Typically, such a film can have a surface resistivity of less than about 10 E¹⁴ ohms/cm², more typically a surface resistivity of less than 10 E¹¹ ohms/cm². The surface resistivity is determined by the technique described in the Examples of this disclosure.

Inorganic pigments treated in accordance with this disclosure are capable of being dispersed throughout the thermoplastic polymer melt. Typically the treated inorganic pigment can be uniformly dispersed throughout the thermoplastic polymer melt. Such pigments may exhibit some minor degree of clumping together within the thermoplastic polymer.

In one embodiment, the disclosure relates to a thermoplastic polymer composition that can be used as a masterbatch. When used as a masterbatch, the thermoplastic polymer can provide both opacity and viscosity attributes to a polymer blend that can be utilized to form shaped articles.

### Thermoplastic Polymers

The thermoplastic polymer is a high molecular weight melt-processable thermoplastic polymer that can be employed together with the treated pigment of this disclosure.

By “high molecular weight” it is meant to describe thermoplastic polymers having a melt index value of 0.01 to 50, typically from 2 to 10 as measured by ASTM method D1238-98. By “melt-processable,” it is meant a thermoplastic polymer that can be extruded or otherwise converted into shaped articles through a stage that involves obtaining the polymer in a molten state.

Thermoplastic polymers which are suitable for use in this disclosure include, by way of example but not limited thereto, polymers of ethylenically unsaturated monomers including olefins such as polyethylene, polypropylene, polybutylene, and copolymers of ethylene with higher olefins such as alpha olefins containing 4 to 10 carbon atoms or vinyl acetate; vinyls such as polyvinyl chloride, polyvinyl esters such as polyvinyl acetate, polystyrene, acrylic homopolymers and copolymers; phenolics; alkyds; amino resins; epoxy resins, polyamides, polyurethanes; phenoxy resins, polysulfones; polycarbonates; polyesters and chlorinated polyesters; polyethers; acetal resins; polyimides; and polyoxyethylenes. Mixtures of polymers are also contemplated.

Thermoplastic polymers suitable for use in the present disclosure also include various rubbers and/or elastomers, either natural or synthetic polymers based on copolymerization, grafting, or physical blending of various diene monomers with the above-mentioned polymers, all as generally known in the art.

Typically, the polymer is selected from the group consisting of polyolefin, polyvinyl chloride, polyamide and polyester, and mixture of these. More typically used polymers are polyolefins. Most typically used polymers are polyolefins selected from the group consisting of polyethylene, polypropylene, and mixture thereof. A typical polyethylene polymer is low density polyethylene and linear low density polyethylene.

In one embodiment of this disclosure a first high molecular weight thermoplastic polymer containing the pigment and the processing aid, is melt blended with a second high molecular weight polymer, which acts as a diluent polymer. The first and second high molecular weight polymers can be the same or different. Typically, the first and second polymers are highly compatible and even more typically, the first and second polymers are the same. The second polymer which acts as a diluent is usually free of pigment and processing aid but can contain other additive (such as an antiblock agent or antioxidant) which can be added by melt blending from a masterbatch containing the high molecular weight polymer and such other additive. While the amount of first high molecular weight polymer can vary depending on the polymer or mixture of polymers, the first polymer is typically present in an amount of from about 1 to about 60 wt. %, typically about 3 to about 50 wt %, even more typically about 3 to about 6 wt. %. based on the total weight of the polymer.

### Other Additives

A wide variety of additives may be present in the thermoplastic polymer composition produced by the process of this disclosure as necessary, desirable or conventional. Such additives include catalysts, initiators, anti-oxidants (e.g., hindered phenol such as butylated hydroxytoluene), blowing agent, ultraviolet light stabilizers (e.g., hindered amine light stabilizers or “HALS”), organic pigments including tinctorial pigments, plasticizers, antiblocking agents (e.g. clay, talc, calcium carbonate, silica, silicone oil, and the like) leveling agents, flame retardants, anti-cratering additives, fluorochemical polymer processing aids, other antistatic agent and the like.

### Preparation of the Thermoplastic Polymer Composition

The present disclosure provides a process for preparing a pigmented high molecular weight thermoplastic polymer composition. Typically, in this process, titanium dioxide is treated in accordance with this disclosure, this step can be performed by any means known to those skilled in the art. Both dry or wet mixing are suitable. In wet mixing, the treated pigment, processing aid or both may be slurried or dissolved in a solvent and subsequently mixed with the other ingredients. Preferably, due to ease and performance, the treated pigment and thermoplastic polymer processing aid are dry mixed.

Any melt compounding techniques, known to those skilled in the art may be used. Generally, the treated pigment, other additives and melt-processable polymer are brought together and then mixed in a blending operation, such as dry blending, that applies shear to the polymer melt to form the pigmented polymer. The melt-processable polymer is usually available in the form of powder, granules, pellets or cubes. Methods for dry blending include shaking in a bag or tumbling in a closed container. Other methods include blending using agitators or paddles. Treated pigment, polymer processing aid and melt-processable polymer may be co-fed using screw devices, which mix the treated pigment, polymer processing aid and melt-processable polymer together before the polymer reaches a molten state.

After mixing or blending, the pigmented polymer is melt blended, using any methods known in the art, including screw feeders, kneaders, high shear mixers, blending mixers, and the like. Typical methods use Banbury mixers, single and twin screw extruders, and hybrid continuous mixers.

Processing temperatures depend on the polymer and the blending method used, and are well known to those skilled in the art. The intensity of mixing depends on the degree of softening.

The pigmented thermoplastic polymer composition produced by the process of this disclosure is useful in production of shaped articles. A shaped article is typically produced by melt blending the pigmented thermoplastic polymer which comprises a first high molecular weight melt-processable polymer, with a second high molecular weight melt-processable polymer to produce the polymer that can be used to form the finished article of manufacture. The pigmented composition and second high molecular weight polymer are melt blended, using any means known in the art, as disclosed hereinabove. In this process, twin-screw extruders are commonly used. Co-rotating twin-screw extruders are available from Werner and Pfleiderer. The melt blended polymer is extruded to form a shaped article.

This disclosure is particularly suitable for producing shaped articles such as tubing, pipes, wire coatings, and films. The process is especially useful for producing films, especially blown films.

In one embodiment, the disclosure herein can be construed as excluding any element or process step that does not materially affect the basic and novel characteristics of the composition or process. Additionally, the disclosure can be construed as excluding any element or process step not specified herein.

Applicants specifically incorporate by reference the entire content of all cited references in this disclosure. Further, when an amount, concentration, or other value or parameter is given as either a range, more specific range, or a list of upper values and lower values, this is to be understood as specifically disclosing all ranges formed from any pair of any upper range limit or more specific value and any lower range limit or specific value, regardless of whether ranges are separately disclosed. Where a range of numerical values is recited herein, unless otherwise stated, the range is intended to include the endpoints thereof, and all integers and fractions within the range. It is not intended that the scope of the disclosure be limited to the specific values recited when defining a range.

### EXAMPLES

The following Examples illustrate the present disclosure. All parts, percentages and proportions are by weight unless otherwise indicated.

### Example 1

A 1000 gm sample of pigmentary titanium dioxide commercially available from E.I. DuPont de Nemours and Co., Wilmington, Del., as R-104, was treated with 14 grams of a 70% solution of trimethoxysilyl propyl octadecyl ammonium chloride in a V-cone blender. To this pigment solution was further added 10 grams of a polyethoxylated polysiloxane commercially sold by Dow Corning as Q2-5211. The sample was heat cured for 1 hour at 100° C. to remove residual solvents. The treated pigment was dispersed into polyethylene at 70 wt. percent using a Banbury Farrel mixer, manufactured by Farrel Corp, Ansonia, Conn. This material, known as a masterbatch, was then let down to 25 wt. percent titanium dioxide in a cast film die to produce a 4 mil (10.16 micron) film. Surface resistivity of the films was measured by placing a section of the film into a surface resistance meter (Trek Model 152, Medina, New York USA) fitted with a concentric ring probe. All values are the average of 5 readings. The surface resistivity of the film was measured and found to be 3.6 E¹¹ ohms/cm².

### Example 3

A 1000 gm sample of pigmentary titanium dioxide commercially available from DuPont as R-104, was treated with 10 grams of a polyethoxylated polysiloxane commercially sold by Dow Corning as Q2-5211 in a V-cone blender. The sample was heat cured for 1 hour at 100° C. to remove residual solvents. The treated pigment was dispersed into polyethylene at 70 wt. percent using a Banbary Farrel mixer. This material, known as a masterbatch, was then let down to 25 wt. percent titanium dioxide in a cast film die to produce a 4 mil (10.16 micron) film. Surface resistivity was measured as described in Example 1. It showed a surface resistivity of 1.0 E¹⁴ ohms/cm².

### Example 4

Example 1 was repeated with the following exception: it was let down to 15 weight percent TiO₂. It has a surface resistivity of 3 E¹¹ ohms/cm².

### Example 5

A 1000 gm sample of pigmentary titanium dioxide commercially available from DuPont as R-101, was treated with 14 grams of a 70% solution of trimethoxysilyl propyl octadecyl ammonium chloride in a V-cone blender. To this pigment solution was further added 10 grams of a polyethoxylated polysiloxane commercially sold by Dow Corning as Q2-5211. The sample was heat cured for 1 hour at 100° C. to remove residual solvents. The treated pigment was dispersed into polyethylene at 70 wt. percent using a Banbary Farrel mixer. This material, known as a masterbatch, was then let down to 25 wt. percent titanium dioxide in a cast film die to produce a 4 mil (10.16 micron) film. The surface resistivity of the film is measured and found to be 3.0 E¹¹ ohms/cm².

### Comparative Example 1

A 1000 gm sample of pigmentary titanium dioxide commercially available from DuPont as R-104, was dispersed into polyethylene at 70 wt. percent using a Banbary Farrel mixer. This material, known as a masterbatch, was then let down to 25 wt. percent titanium dioxide in a cast film die to produce a 4 mil (10.16 micron) film. Surface resistivity was measured as described in Example 1. It showed a surface resistivity of 3.9 E¹⁶ ohms/cm².

### Comparative Example 2

A 1000 gm sample of pigmentary titanium dioxide commercially available from DuPont as R-104, was treated with 14 grams of a 70% solution of trimethoxysilyl propyl octadecyl ammonium chloride in a V-cone blender. The sample was heat cured for 1 hour at 100° C. to remove residual solvents. The treated pigment was dispersed into polyethylene at 70 wt. percent using a Banbary Farrel mixer. This material, known as a masterbatch, was then let down to 25 wt. percent titanium dioxide in a cast film die to produce a 4 mil (10.16 micron) film. Surface resistivity was measured as described in Example 1. It showed a surface resistivity of 3 E¹⁶ ohms/cm².

The description of illustrative and preferred embodiments of the present disclosure is not intended to limit the scope of the disclosure. Various modifications, alternative constructions and equivalents may be employed without departing from the true spirit and scope of the appended claims.

1-30. (canceled)

31. A shaped polymer article having antistatic properties comprising a thermoplastic polymer and an antistatic agent in amount ranging from about 0.01 to about 20 wt. %, wherein the antistatic agent comprises an inorganic pigment having a siloxane treatment, the siloxane being selected from the group consisting of
(a) a siloxane having the structure: 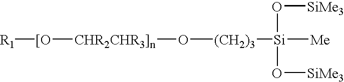
wherein
R₁, R₂ and R₃ are independently hydrogen atom, or C₁-C₂₀ alkyl group and n is independently an integer between 1 and 40, or
(b) a reaction product of propylene oxide and ethylene oxide and a siloxane having the structure: 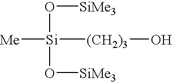
wherein Me is methyl.

32. The shaped polymer article of claim 31 wherein R₁ is a hydrogen atom or methyl group and R₂ and R₃ are hydrogen atoms and n is an integer ranging from 1 to 40.

33. The shaped polymer article of claim 31 wherein R₁, R₂ and R₃ are hydrogen atoms and n is an integer ranging from 1 to 40.

34. The shaped polymer article of claim 31 wherein the siloxane is a polyethoxylated siloxane selected from the group consisting of poly(oxy-1,2-ethanediyl), a-[3-[1,3,3,3-tetramethyl-[(trimethylsilyl)oxy]disiloxanyl]propyl]-w-hydroxy; methyl capped polyethoxylated polysiloxanes; and poly(oxy-1,2-ethanediyl), a-methyl-w-[3-[1,3,3,3-tetramethyl-1-[(trimethylsilyl)oxy]disiloxanyl]propoxy].

35. The shaped polymer article of claim 31 wherein the inorganic pigment is selected from the group consisting of ZnS, TiO₂, CaCO₃, BaSO₄, ZnO, MoS₂, silica, talc and clay.

36. The shaped polymer article of claim 35 wherein the inorganic pigment is TiO₂.

37. The shaped polymer article of claim 36 wherein the titanium dioxide is silanized by surface treatment with a silane.

38. The shaped polymer article of claim 37 wherein the silane is selected from the group consisting of 3-trimethoxysilyl propyl octyl dimethyl ammonium chloride, 3-trimethoxysilyl propyl octyl dimethyl ammonium chloride, 3-trimethoxysilyl propyl decyl dimethyl ammonium chloride, 3-trimethoxysilyl propyl hexadecyl dimethyl ammonium chloride, and 3-trimethoxysilyl propyl octadecyl dimethyl ammonium chloride.

39. The shaped polymer article of claim 31 wherein the thermoplastic polymer is selected from the group consisting of a polymer of ethylenically unsaturated monomer; polyvinyl; polyvinyl ester; polystyrene; acrylic homopolymer and copolymer; phenolic; alkyd; amino resin; epoxy resin; polyamide; polyurethane; phenoxy resin; polysulfone; polycarbonate; polyester and chlorinated polyester; polyether; acetal resin; polyimide; and polyoxyethylene.

40. The shaped polymer article of claim 39 wherein the polymer of ethylenically unsaturated monomer is a polyolefin.

41. The shaped polymer article of claim 40 wherein the polyolefin is selected from the group consisting of polyethylene, polypropylene, polybutylene, and copolymer of ethylene with higher olefin or polyvinyl acetate.

42. The shaped polymer article of claim 31 further comprising another antistatic agent which is different from the siloxane.

43. The shaped polymer article of claim 31 wherein the antistatic agent is made by a process comprising:
(i) metering the siloxane and optionally a silane into a flow restrictor, having an inlet and an outlet, a motive gas, to create a zone of turbulence at the outlet of the flow restrictor thereby atomizing the siloxane compound and optionally the silane to form an atomized liquid; and
(ii) contacting the inorganic pigment with the atomized liquid to form the antistatic agent.

44. The shaped polymer article of claim 31 wherein the shaped article is a film.

45. The shaped polymer article of claim 44 wherein the surface resistivity is less than about 10 E¹⁴ ohms/cm².

46. The shaped polymer article of claim 44 wherein the surface resistivity is less than 10 E¹¹ ohms/cm².
